(19) United States
(12) Patent Application Publication
(10) Pub. No.: US 2016/0208836 A1
(43) Pub. Date: Jul. 21, 2016

(54) Clamping Connector

(71) Applicant: Hestex System B.V., Apeldoorn (NL)

(72) Inventor: Arie SINT NICOLAAS, Bonaire (NL)

(21) Appl. No.: 15/001,316

(22) Filed: Jan. 20, 2016

(30) Foreign Application Priority Data
Jan. 21, 2015 (EP) 151520152

(51) Int. Cl. F16B 2/14; F16B 2/04

(52) U.S. Cl. CPC F16B 2/14; F16B 2/04

(57) ABSTRACT

The disclosure relates to a clamping connector for the detachable junction of two elements, the first one of which comprises an undercut longitudinal groove and the second one of which comprises a receiving space for a housing of the clamping connector, wherein the housing of the clamping connector comprises two end faces arranged opposite each other in the longitudinal direction of the housing and at least one side wall connecting the two end faces, comprising a transmission element which is accommodated in the housing, wherein the transmission element can be displaced between a clamping position and an assembly position in the longitudinal direction of the housing by means of an actuation element, wherein the transmission element drives an anchor element for the arrangement in an undercut longitudinal groove, which anchor element projects beyond one of the end faces of the housing in the longitudinal direction both in the clamping position and in the assembly position, wherein the transmission element is partially retracted into the housing in the clamping position and as a result the transmission element as well as the anchor element are transversely deflected with respect to the longitudinal direction of the housing by a ramp mechanism which is arranged in the movement path, wherein a recess is formed in the side wall of the housing, wherein a clamping jaw of the transmission element projects through the recess beyond the side wall of the housing in the clamping position.

### CROSS-REFERENCE TO RELATED APPLICATIONS

This application claims priority to European Application No. 151520152, filed on Jan. 21, 2015. The entire disclosure of the above application is incorporated herein by reference.

### FIELD

The disclosure relates to a clamping connector for the detachable junction of two elements, the first one of which comprises an undercut longitudinal groove and the second one of which comprises a receiving space for a housing of the clamping connector, wherein the housing of the clamping connector comprises two end faces arranged opposite each other in the longitudinal direction of the housing and at least one side wall connecting the two end faces, comprising a transmission element which is accommodated in the housing, wherein the transmission element can be displaced between a clamping position and an assembly position in the longitudinal direction of the housing by means of an actuation element, wherein the transmission element drives an anchor element for the arrangement in an undercut longitudinal groove, which anchor element projects beyond one of the end faces of the housing in the longitudinal direction both in the clamping position and in the assembly position, wherein the transmission element is partially retracted into the housing in the clamping position and as a result the transmission element as well as the anchor element are transversely deflected with respect to the longitudinal direction of the housing by a ramp mechanism which is arranged in the movement path.

### BACKGROUND

This section provides background information related to the present disclosure which is not necessarily prior art.

Such clamping connectors are known from the state of the art. They are devices for connecting two or more profile elements with each other. Such profile elements and clamping connectors are used for quickly mounting and/or dismounting fair structures, shelf systems and the like.

It is for example known from EP 2 738 317 A1 to use so called wall construction panel elements for the mobile construction of walls. These ones comprise a flat wall construction panel, all the four edges of which are provided with profile elements which altogether form a frame. The individual profile elements are connected in the corner areas of the frame by means of generic clamping connectors. For this, the clamping connector is inserted into a first element, such as for example a profile element. For this purpose, the element comprises a receiving space for the housing of the clamping connector. Afterwards, a second element with an undercut longitudinal groove, for example a corresponding profile element, is plugged on the anchor elements which project from the end face of the housing of the clamping connector. The anchor elements are then transferred into the clamping position by actuating the actuation element, wherein in this configuration, the anchor elements clutch the undercut longitudinal groove from behind. The two (profile) elements are then safely connected to each other.

A generic clamping connector is known from EP 1 234 985 B1. In order to be able to flexibly use the clamping connector disclosed there and to make for example also use of it in connection with wooden elements, an adapter element is proposed which is first inserted into the element which provides the receiving space. Only afterwards, the real clamping connector with the housing thereof will be plugged into this adapter.

The known clamping connectors have principally proven successful. The use of the adapter however entails that different adapters have to be provided for different receiving spaces. Furthermore, the assembly has to be carried out in two steps, since first the adapter is inserted into the receiving space and only afterwards the real clamping connector can be mounted. In so far, in the state of the art even only small deviations of the geometry of the receiving space require the use of different adapters and/or different clamping connectors.

### SUMMARY

Based upon this state of the art, it is an object of the disclosure to simplify the handling of a generic clamping connector and to reduce the assembly time. Furthermore, the number of the parts to be kept in stock shall be reduced.

For achieving this aim, the disclosure proposes that a recess is formed in the side wall of the housing, wherein a clamping jaw of the transmission element, especially leaf spring element, projects through the recess beyond the side wall of the housing in the clamping position.

The highlight of the disclosure is that an actuation of the transmission element, especially leaf spring element, for moving from the assembly position into the clamping position does not only lead to a clamping or spreading apart motion of the anchor elements projecting from the end face of the housing, but a spreading apart motion in the area of the housing itself will also take place. The spreading apart motion is provoked by the clamping jaw projecting through the recess in the housing beyond the side wall of the housing. In other words, the thickness or height of the housing is increased by the clamping jaw. In the clamping position, a portion of the housing is spread apart, which portion is inserted into the element comprising the receiving space for the housing in case of proper use.

A double tensioning of the clamping connector thus takes place by one and the same actuation of the actuation element. As already known from the state of the art, the anchor elements engage behind the undercut groove and thus secure the first element with the undercut groove, on the one hand. Simultaneously, the clamping jaw passes through the recess out of the housing and thus ensures that the clamping connector will also engage with the second element. Thanks to the clamping jaw which projects from the recess, the housing will be firmly clamped in the receiving space of the second element. As a result, the two elements to be joined together are safely and firmly connected to each other. All this is done in some few simple steps. Thus, only the clamping connector has to be inserted into the receiving space of the second element, the first element has to be plugged onto the anchor elements and afterwards the actuation element has to be actuated. In many cases, the adapter element known from the state of the art can be completely omitted. This reduces the number of parts to be kept in stock to a considerable extent.

Furthermore, the clamping jaw, which will project out of the housing if a transfer into the clamping position takes place, can compensate a possible clearance between the housing, on the one hand, and the receiving space in the second element, on the other hand. This makes it possible that according to the disclosure one and the same design of a clamping connector can be equally mounted in receiving spaces comprising for example a thickness of 8 mm and a thickness of 6 mm. One and the same clamping connector can be equally used in two receiving spaces, if there are only small geometric differences between the receiving spaces.

The transmission element serves to transform an exclusively rotating movement of the actuation element into an at least also translational motion of the anchor element and, according to the disclosure, the clamping jaw. The transmission element can be preferably designed as leaf spring element. If in the following it is referred to the leaf spring element, this also applies to the transmission element which can be understood more generally, unless the spring elastic features of the leaf spring element are specifically important. The anchor element can be an integral part of the transmission element or leaf spring element.

The clamping jaw is a device for establishing a non-positive connection with a wall defining the recess. The clamping jaw can comprise a friction increasing surface, for example in form of a friction lining.

According to an advantageous embodiment of the disclosure, the clamping jaw is arranged between the anchor element and an end of the leaf spring element, which end is opposite the anchor element. With respect to the longitudinal direction of the housing, the clamping jaw is placed inside the housing both in the assembly position and in the clamping position. The clamping jaw and the anchor element thus serve to get the clamping connector engaged with different parts. Advantageously, the clamping connector essentially comprises the same geometric design as the initially described clamping connectors known from the state of the art. In so far, a clamping connector according to the disclosure is downward compatible and can be used in a particularly flexible manner. Herein, it is advantageous, if the clamping jaw can be elastically bent. In a receiving space, which does not allow the clamping jaw to project out of the recess, the clamping jaw can avoid this forced guidance by means of elastic bending.

The clamping jaw can be formed by a bulged portion of the leaf spring element. The clamping jaw can be polygonal or steadily curved. It can have a convex shape. The clamping jaw can have the same material thickness as the other leaf spring element. In so far, the clamping jaw can be easily integrated in the base body of the leaf spring element, for example by means of bending.

The recess preferably leads to a face edge limiting the housing in the longitudinal direction. The recess can be formed by a cut extending in U-form, which is positioned on the face edge. Preferably, the recess is exclusively formed in a broad side which connects two narrow sides of the housing to each other. The two narrow sides however still extend up to the face edge of the housing. This allows achieving a high stability of the housing, such that the functionality of a clamping connector according to the disclosure is not worse than the one of the state of the art.

The recess can be arranged in the housing in a material-removing manner. The recess can for example be arranged in the housing by means of a machining process, such as milling. The manufacture of the housing can thus be very flexible and be realized as desired, which simplifies the manufacture of the clamping connector and thus reduces the costs related thereto.

The width of the recess can correspond to the width of the leaf spring element. This design also includes such embodiments, in which the width of the recess is slightly oversized with respect to the width of the leaf spring element. In this connection it is decisive that the recess can be comparatively narrow, which increases the stability of the housing.

According to an advantageous embodiment of the disclosure, the leaf spring element comprises two tongues separated from each other by a cut in the longitudinal direction. Both tongues can respectively comprise one anchor element at their ends projecting from the end face of the housing. The two tongues can be mirror images of each other. Both tongues can comprise a clamping jaw. In case of proper use, the transfer of the clamping connector from the assembly position into the clamping position causes both the two anchor elements of the two tongues to be spread apart and thus to ensure a safe hold in the undercut longitudinal groove and the two clamping jaws of the tongues to be spread apparat into opposite directions. As a result, the clamping connector is thus held on both elements in a particularly safe manner, with simultaneously a very simple assembly.

It can be provided for the leaf spring element comprising two tongues that the housing comprises two recesses, wherein respectively one recess is formed on one of the broad sides, wherein the recesses are spaced from each other in the direction of width. On each broad side of the housing, the recesses only extend over a little less than half the broad side, which leads to a high stability of the housing.

According to an advantageous embodiment of the disclosure, the leaf spring element is placed on a web which extends in the direction of width throughout the housing, wherein the clamping jaw and the web together form the ramp mechanism. The web and the leaf spring element, especially the clamping jaw, slide and/or roll on each other. One or both of these parts are ramp-shaped. Ramp-shaped means that the part comprises a contact surface having an inclination into the transverse direction with respect to the longitudinal direction of the housing. A movement of the leaf spring element in the housing into the longitudinal direction is thus at least partly converted into a movement into the transverse direction by means of the ramp mechanism.

In the assembly position, the rear side of the clamping jaw of the leaf spring element can encompass the web. The rear side of the clamping jaw is the side which is opposite an outer side of the clamping jaw destined for the contact with the inside of the receiving space. The rear side of the clamping jaw is directed into the direction of the inside of the housing of the clamping connector. It can be provided that the leaf spring element is released in the assembly position. In the clamping position however, the rear side of the clamping jaw of the leaf spring element is pushed onto the web by displacement of the leaf spring element.

Starting from a base body of the leaf spring element, the clamping jaw is higher than the anchor element. Thereby, the clamping connector can also be arranged in such receiving spaces, the thickness of which is greater than the thickness of the undercut of the undercut longitudinal groove for the anchor elements.

In the clamping position, the clamping jaw projects at least 1 mm, preferably 2 mm, through the recess beyond the side wall of the housing. In this manner, the clamping connector can also be mounted in such recesses, the thickness of which is clearly shorter than the thickness of the clamping connector housing itself.

### DRAWINGS

The drawings described herein are for illustrative purposes only of selected embodiments and not all possible implementations, and are not intended to limit the scope of the present disclosure.

Advantages and features of the disclosure will become apparent from the following description by means of the figures. Herein:

FIG. 1 shows a perspective view of a first embodiment of a clamping connector according to the disclosure;

FIG. 2 is a top view of a longitudinal cut through the clamping connector according to FIG. 1 in the assembly position:

FIG. 3 shows a cut along line III-Ill in FIG. 2;

FIG. 4 is a top view of a longitudinal cut through the clamping connector according to FIG. 1 in the clamping position;

FIG. 5 shows a cut along line V-V in FIG. 4 and

FIG. 6 shows a second embodiment of a clamping connector according to the disclosure.

Corresponding reference numerals indicate corresponding parts throughout the several views of the drawings.

### DESCRIPTION

Example embodiments will now be described more fully with reference to the accompanying drawings.

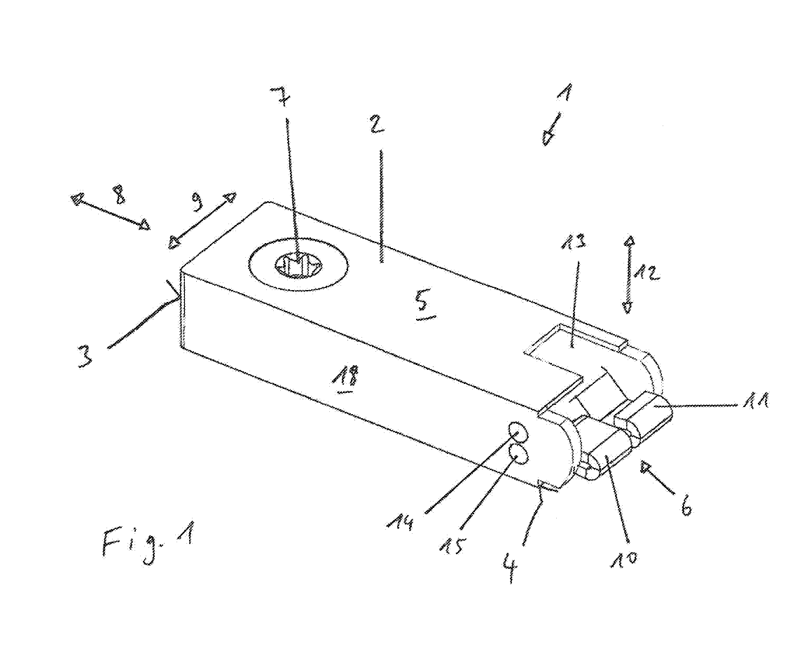

FIG. 1 shows a first embodiment of a clamping connector 1. This one comprises a housing 2. The housing 2 has an essentially rectangular-shaped design. It comprises two broad sides, one of which is referred to as side wall 5. The two broad sides are connected to each other by narrow sides 18. The housing 2 is finally limited by end faces 3, 4 arranged opposite each other.

A transmission element 6 in form of a leaf spring element is located in the housing (in the following the reference numeral 6 will be used for the leaf spring element). In the present case, the leaf spring element 6 comprises two tongues, which are separated from each other by a cut in the longitudinal direction 8. Both tongues of the leaf spring element 6 respectively comprise an anchor element 10, 11 on their ends projecting from the end face of the housing 2.

An actuation element 7 is arranged in the housing 2. This one serves to shift the leaf spring element 6 between a clamping position and an assembly position.

A recess 13 is arranged in the housing 2 on the side of the end face. The recess 13 is approximately as wide as one of the tongues of the leaf spring element 6.

The functioning of the clamping connector 1 will be generally described in the following with reference to FIGS. 1 through 5, unless otherwise explicitly stated.

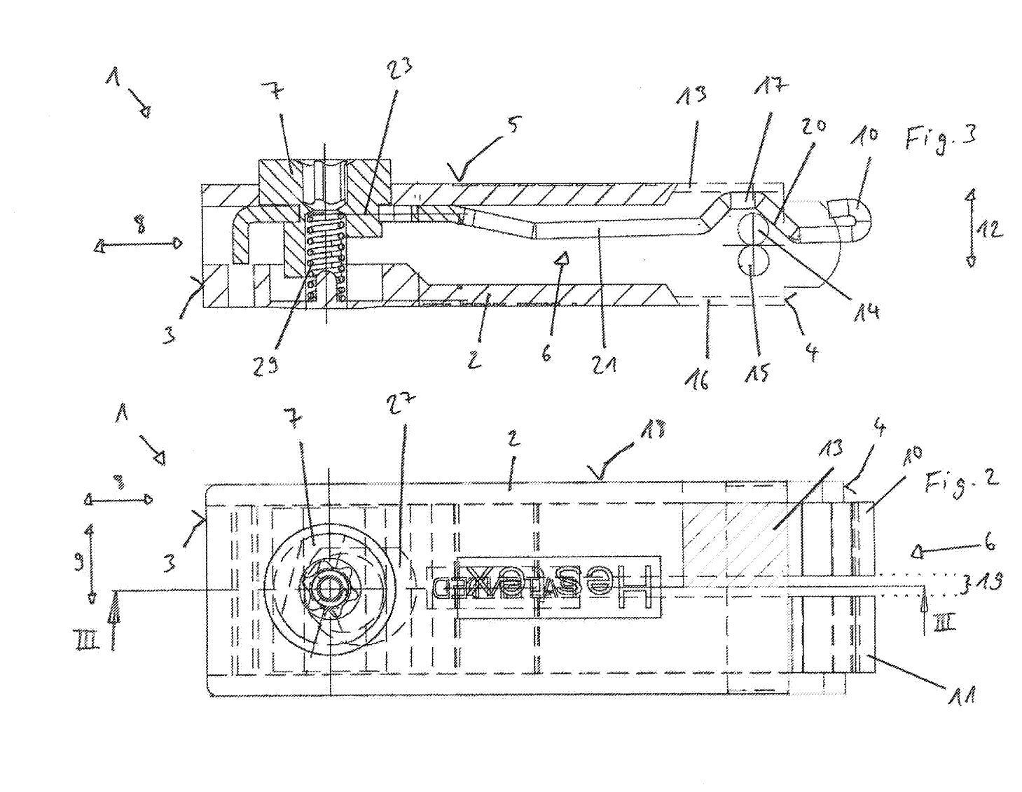

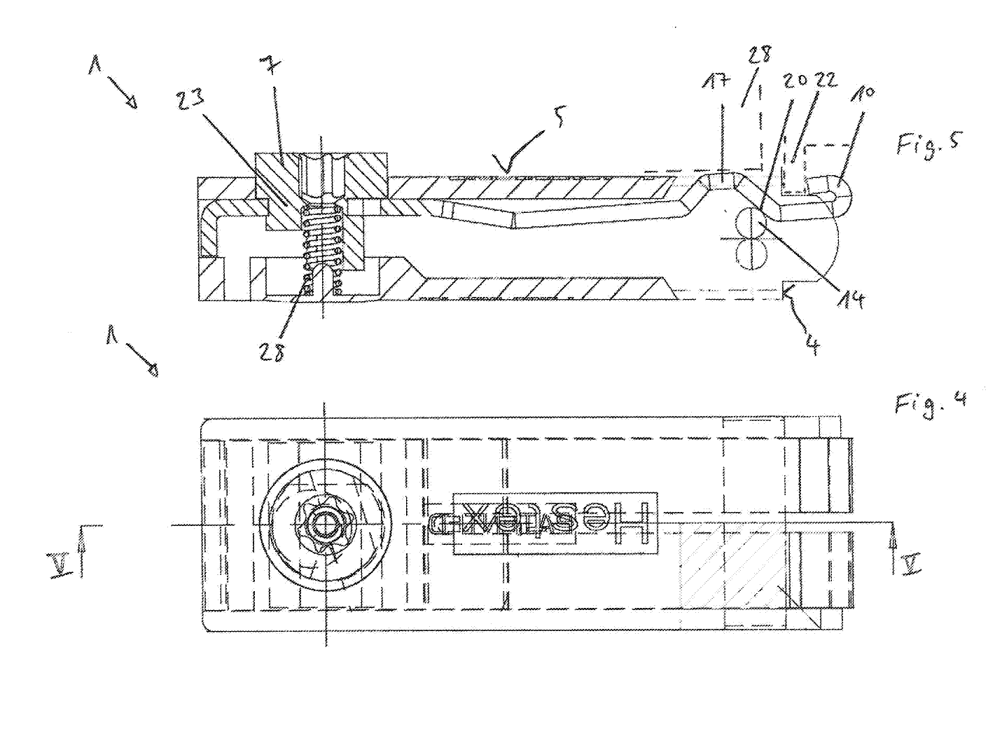

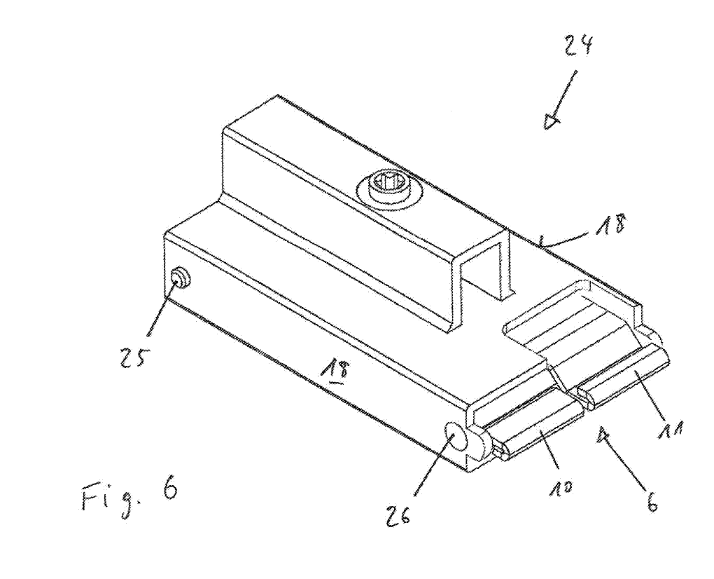

The leaf spring element 6 arranged inside the housing 2 is formed in one piece. It comprises a common part which is actively related to the actuation element 7. An opening 27 is formed in this part of the leaf spring element 6. The opening 27 is circular, wherein one segment of the circle however is not designed as an opening. The actuation element 7 is inserted into this opening 27. The actuation element 7 is in contact with the side wall limiting the opening 27 via a cam profile 23. Caused by a rotation of the actuation element 7, the cam profile 23 slides on the side wall of the opening 27, wherein the leaf spring element 6 can be thereby moved between the assembly position shown in the FIGS. 2 and 3 and the clamping position shown in the FIGS. 4 and 5.

As already mentioned, a second part of the leaf spring element 6 is divided by a cut in the longitudinal direction 8 into the two tongues. Each tongue comprises a base body 21, on the face side end of which the anchor element 10, 11 is arranged. Furthermore, a clamping jaw 17 is formed in the base body 21. In the present case, the clamping jaw is designed as a polygonal bulge. The clamping jaw 17 is located beneath the recess 13. The rear side of the clamping jaw 17 encompasses a web 14. The web 14 extends into the direction of width 9 throughout the housing 2. It is placed in the two narrow sides 18 of the housing 2.

Another web 15 is provided for the other tongue. But it is also imaginable that the two webs are formed in one piece.

Thanks to the polygonal design, the clamping jaw 17 comprises a ramp 20 on its rear side. The ramp 20 extends in an oblique manner with respect to the longitudinal direction 8 of the housing, namely sloping in the transverse direction 12 or direction of height. If the leaf spring element is now displaced into the direction of the clamping position by rotation of the actuation element 7, the clamping jaw 17 with its ramp 20 will slide and/or roll on the web 14. The displacement of the leaf spring element 6 in the longitudinal direction 8 is thereby deflected into the transverse direction 12 corresponding to the slope of the ramp 20. As a result, the leaf spring element 6 will be elastically deflected into the transverse direction 12. It will finally arrive in the position represented in FIG. 5. It is striking that the clamping jaw 17 now projects from the housing 2 beyond the outer surface of the side wall 5. In the position shown in FIG. 5, the clamping jaw 17 would thus press against the wall of a receiving space for the housing 2. Thereby, the clamping connector 1 would be locked in the receiving space.

Simultaneously, the anchor element 10 will also be deflected. In the position shown in FIG. 5 it engages behind an undercut groove in an element 22 which is represented with a dashed line. The clamping connector 1 thus ensures altogether that the two elements 22, 28 are safely connected to each other and this by locking the second element 28 by means of the clamping jaw 17, on the one hand, and by engaging behind the groove in the first element 22 by means of the anchor element 10, on the other hand.

In the element 28 which provides the receiving space, another receiving space for the head of the actuation element 7 is provided. This one is however not represented. The insertion of the clamping connector 1 into the receiving space in the element 28 takes place as follows. The actuation element 7 is turned into the assembly position shown in FIG. 3. The actuation element 7 is accommodated in the housing 2 by a spring 29. It can be pushed into the housing 2 against the force of the spring 29, such that the head of the actuation element 7 does no more protrude from the side wall 5. In this condition, the clamping connector 1 is inserted into the receiving space in the element 28. If the clamping connector 1 reaches its intended position, the actuation element 7 will shoot up due to the force of the spring 29 into the correspondingly provided receiving space for the actuation element 7. In a first step, the clamping connector is then held in a positive-locking manner with respect to its longitudinal direction 8 in the receiving space of the element 28.

Afterwards, the first element 22 comprising the undercut groove will be plugged onto the anchor elements 10, 11. Then, the actuation element 7 is turned, such that the leaf spring element 6 is transferred from the assembly position into the clamping position. Here, the clamping jaw 17 will extend, as already described above, whereby the housing 2 is locked in the receiving space of the element 28. The anchor elements 10, 11 simultaneously get into the undercut groove, such that finally the two elements 22, 28 are safely held one to another.

The respectively second tongue, which is not represented in the FIGS. 3 and 5 and which comprises the anchor element 11, moves accordingly in a mirror-inverted manner with respect to the represented tongue. It slides or rolls on the web 15. A corresponding recess 16 is provided for it in the wall of the housing 2 opposite the side wall 5. The two tongues are separated and especially also spaced from each other by a cut 19 in the longitudinal direction 8 of the housing, as already described above.

FIG. 6 shows a second embodiment of the clamping connector 24 according to the disclosure. This one principally functions identically to the above described clamping connector 1. It is however considerably wider, which in particular results in a clearly wider leaf spring element 6. In the present case, a variant has been chosen, in which a common web 26 for both tongues of the leaf spring element 6 is provided.

The clamping connector 24 still comprises an optional cam 25. The cam 25 can be provided on both narrow sides 18 of the clamping connector 24. It can be accommodated inside the housing 2 with interposition of a spring, in such a way that it can be pushed into the housing 2 against the force of the spring, and if it reaches an intended end position, it will shoot out again by the force of the spring into a corresponding receiving space for the cam 25. The cam thus serves to further secure the arrangement of the clamping connector 24 in the receiving space of the corresponding element 28. The clamping connector 1 could also comprise a cam 25.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A clamping connector for the detachable junction of two elements, the first one of which comprises an undercut longitudinal groove and the second one of which comprises a receiving space, the clamping connector comprising:
a housing comprising two end faces arranged opposite each other in the longitudinal direction of the housing and at least one side wall connecting the two end faces; and
a transmission element which is accommodated in the housing, wherein the transmission element can be displaced between a clamping position and an assembly position in the longitudinal direction of the housing by means of an actuation element, wherein the transmission element drives an anchor element for the arrangement in an undercut longitudinal groove, which anchor element projects beyond one of the end faces of the housing in the longitudinal direction both in the clamping position and in the assembly position, wherein the transmission element is partially retracted into the housing in the clamping position and as a result the transmission element as well as the anchor element are transversely deflected with respect to the longitudinal direction of the housing by a ramp mechanism which is arranged in the movement path, wherein a recess is formed in the side wall of the housing, wherein a clamping jaw of the transmission element projects through the recess beyond the side wall of the housing in the clamping position.

2. A clamping connector according to claim 1, wherein the transmission element is designed as leaf spring element.

3. A clamping connector according to claim 1, wherein the clamping jaw is arranged between the anchor element and an end of the transmission element, which end is opposite the anchor element.

4. A clamping connector according claim 1, wherein the clamping jaw is formed by a bulged portion of the transmission element.

5. A clamping connector according to claim 1, wherein the recess leads to a face edge limiting the housing in the longitudinal direction.

6. A clamping connector according to claim 1, wherein the recess is exclusively formed in a broad side which connects two narrow sides of the housing to each other.

7. A clamping connector according to claim 1, wherein the recess is arranged in the housing in a material-removing manner.

8. A clamping connector according to claim 1, wherein the width of the recess corresponds to the width of the transmission element.

9. A clamping connector according to claim 1, wherein the transmission element comprises two tongues separated from each other by a cut in the longitudinal direction.

10. A clamping connector according to claim 9, wherein the housing comprises two recesses, wherein respectively one recess is formed on one of the broad sides, wherein the recesses are spaced from each other in the direction of width.

11. A clamping connector according to claim 1, wherein the transmission element, in particular two tongues of the leaf spring element, is placed on a web which extends in the direction of width throughout the housing, wherein the clamping jaw and the web together form the ramp mechanism.

12. A clamping connector according to claim 11, wherein in the assembly position, the rear side of the clamping jaw of the transmission element encompasses the web.

13. A clamping connector according to claim 11, wherein in the clamping position, the rear side of the clamping jaw of the transmission element is pushed onto the web by displacement of the transmission element, especially the leaf spring element.

14. A clamping connector according to claim 1, wherein starting from a base body of the transmission element, the clamping jaw is higher than the anchor element.

15. A clamping connector according to claim 1, wherein in the clamping position, the clamping jaw projects at least 1 mm through the recess beyond the side wall of the housing.
